(19) United States
(12) Patent Application Publication
(10) Pub. No.: US 2026/0180327 A1
(43) Pub. Date: Jun. 25, 2026

(54) METHOD FOR COORDINATED DISPATCH OF HYBRID ENERGY STORAGE SYSTEMS TO ADAPT TO PEAK LOADS IN EXTREME SCENARIOS, AND DEVICE

(71) Applicants: North China Electric Power University, Beijing (CN); State Grid Gansu Electric Power Company, Lanzhou City (CN)

(72) Inventors: Nian LIU, Beijing (CN); Kai Jiang, Beijing (CN); Jiye Wang, Lanzhou City (CN); Lin Yang, Lanzhou City (CN); Wen Tang, Lanzhou City (CN); Yuzhong Li, Lanzhou City (CN); Xinwei Wang, Lanzhou CIty (CN); Lei Wang, Beijing (CN)

(21) Appl. No.: 19/400,819

(22) Filed: Nov. 25, 2025

(30) Foreign Application Priority Data
Dec. 20, 2024 (CN) 202411884287.9

(51) Int. Cl. H02J 3/28; G06N 3/0442; G06N 3/0464; G06N 3/08; H02J 3/00; H02J 3/38; H02J 101/40; H02J 103/30

(52) U.S. Cl. CPC H02J 3/28; G06N 3/0442; G06N 3/0464; G06N 3/08; H02J 3/004; H02J 3/381; H02J 2101/40; H02J 2103/30

(57) ABSTRACT

Provided are a method for coordinated dispatch of hybrid energy storage systems to adapt to peak loads in extreme scenarios, and a device. The method includes: generating an extreme scenario set; generating an uncertainty set of extreme scenarios; generating an aggregated model for a hybrid energy storage power station; constructing an intra-region robust optimization model for wind-photovoltaic-thermal-energy storage based on the aggregated model for the hybrid energy storage power station and the uncertainty set of extreme scenarios, and solving the intra-region robust optimization model for wind-photovoltaic-thermal-energy storage using a Black-winged Kite Algorithm (BKA) to obtain a charging and discharging power of the hybrid energy storage power station; and generating an internal coordinated dispatch plan for the hybrid energy storage power station using a niche-based gradient-directed evolution algorithm and a dispatch plan prediction model according to the charging and discharging power of the hybrid energy storage power station.

### CROSS REFERENCE TO RELATED APPLICATION

This patent application claims the benefit and priority of Chinese Patent Application No. 202411884287.9, filed with the China National Intellectual Property Administration on Dec. 20, 2024, the disclosure of which is incorporated by reference herein in its entirety as part of the present application.

### TECHNICAL FIELD

The present disclosure relates to the field of energy storage dispatch, and in particular, to a method for coordinated dispatch of hybrid energy storage systems to adapt to peak loads in extreme scenarios, and a device.

### BACKGROUND

With the continuous large-scale integration of new energy sources into the grid, the proportion of electricity generated from new energy sources has been increasing year by year. Frequent extreme weather events cause drastic fluctuations in the output of new energy sources, while the rapid development of the tertiary industry further widens the peak-valley difference in electrical load. Under the influence of these bidirectional uncertainties, the power grid faces a challenging situation in maintaining the balance between power supply and demand. Currently, new types of energy storage systems, represented by electrochemical energy storage, possess bidirectional rapid charging and discharging capabilities and energy transfer characteristics, and provide support in terms of charging/discharging power and duration when combined with compressed air energy storage systems, ensuring the reliable and stable development of the new power system. Under the current circumstances, the mechanism by which hybrid energy storage power stations support grid stability during extreme scenarios remains unclear. Additionally, energy storage systems of different scales within hybrid energy storage power stations are relatively independent at the modeling level, and there is a lack of methodological guidance for coordinated dispatch. Moreover, there is also a lack of effective means for model aggregation and equivalence of the external output characteristics of energy storage power stations. Therefore, it is necessary to develop a method for coordinated dispatch of hybrid energy storage systems to adapt to peak loads in extreme scenarios, so as to ensure the stable supply capacity of the power grid under extreme conditions.

### SUMMARY

An objective of the present disclosure is to provide a method for coordinated dispatch of hybrid energy storage systems to adapt to peak loads in extreme scenarios, and a device, which can achieve rapid decision-making for internal coordinated dispatch plans of hybrid energy storage power stations under extreme scenarios, thereby ensuring the stable supply capacity of the power grid under extreme conditions.

To achieve the above objective, the present disclosure provides the following technical solutions.

According to a first aspect, the present disclosure provides a method for coordinated dispatch of hybrid energy storage systems to adapt to peak loads in extreme scenarios, applied to a hybrid energy storage power station, including: generating an extreme scenario set using a clustering algorithm for peak-valley difference characteristics according to wind power output, photovoltaic output, and electrical load data in a historical time period; generating an uncertainty set of extreme scenarios using a fast convex hull algorithm according to the wind power output, the photovoltaic output, and the electrical load data in the extreme scenario set; generating, based on a general energy storage model in a State of Charge (SoC) form, an aggregated model for the hybrid energy storage power station using a multi-objective generalized normal distribution optimization (MOGNDO) algorithm; constructing an intra-region robust optimization model for wind-photovoltaic-thermal-energy storage based on the aggregated model for the hybrid energy storage power station and the uncertainty set of extreme scenarios, and solving the intra-region robust optimization model for wind-photovoltaic-thermal-energy storage using a Black-winged Kite Algorithm (BKA) to obtain a charging and discharging power of the hybrid energy storage power station; and generating an internal coordinated dispatch plan for the hybrid energy storage power station using a niche-based gradient-directed evolution algorithm and a dispatch plan prediction model according to the charging and discharging power of the hybrid energy storage power station, where the dispatch plan prediction model is constructed based on a Convolutional Neural Network (CNN), an improved Sparrow Search Algorithm (ISSA), and a Bidirectional Gated Recurrent Unit (BiGRU).

Optionally, the generating the extreme scenario set using the clustering algorithm for peak-valley difference characteristics according to the wind power output, the photovoltaic output, and the electrical load data in the historical time period includes: acquiring the wind power output, the photovoltaic output, and the electrical load data in the historical time period; constructing an index set of wind power characteristics, photovoltaic characteristics, and electrical load characteristics according to the wind power output, the photovoltaic output, and the electrical load data in the historical time period; performing clustering using an improved k-means clustering algorithm according to the index set of the wind power characteristics, the photovoltaic characteristics, and the electrical load characteristics, to obtain a cluster partitioning result, where the improved k-means clustering algorithm, based on a k-means clustering algorithm, involves performing cluster partitioning of a full sample set by using a clustering result of a small sample set as an initial clustering center of the full sample set, to obtain the cluster partitioning result, the full sample set is the index set of the wind power characteristics, the photovoltaic characteristics, and the electrical load characteristics, and the small sample set is obtained by extracting a preset proportion from the full sample set; and generating the extreme scenario set according to the cluster partitioning result.

Optionally, the generating the uncertainty set of extreme scenarios using the fast convex hull algorithm according to the wind power output, the photovoltaic output, and the electrical load data in the extreme scenario set includes: constructing probability density functions of wind power output, photovoltaic output, and electrical load under extreme scenarios using a kernel density estimation method according to the wind power output, the photovoltaic output, and the electrical load data in the extreme scenario set; performing random sampling using a Monte Carlo sampling method according to the probability density functions of wind power output, photovoltaic output, and electrical load under extreme scenarios, to generate a random scenario set; and generating the uncertainty set of extreme scenarios using the fast convex hull algorithm according to the random scenario set.

Optionally, the generating, based on the general energy storage model in the SoC form, the aggregated model for the hybrid energy storage power station using the MOGNDO algorithm includes: constructing a multi-objective aggregated model for the hybrid energy storage power station based on the general energy storage model in the SoC form; solving the multi-objective aggregated model for the hybrid energy storage power station using the MOGNDO algorithm to obtain a Pareto optimal solution set; and converting the multi-objective aggregated model for the hybrid energy storage power station using a compromise solution strategy considering fairness according to the Pareto optimal solution set, to generate the aggregated model for the hybrid energy storage power station.

Optionally, the constructing the intra-region robust optimization model for wind-photovoltaic-thermal-energy storage based on the aggregated model for the hybrid energy storage power station and the uncertainty set of extreme scenarios, and solving the intra-region robust optimization model for wind-photovoltaic-thermal-energy storage using the BKA to obtain the charging and discharging power of the hybrid energy storage power station includes: constructing the intra-region robust optimization model for wind-photovoltaic-thermal-energy storage based on the aggregated model for the hybrid energy storage power station and the uncertainty set of extreme scenarios; converting the intra-region robust optimization model for wind-photovoltaic-thermal-energy storage into a max-min problem model; converting the max-min problem model into a single-layer max problem model using strong duality theory; and solving the single-layer max problem model using the BKA to obtain the charging and discharging power of the hybrid energy storage power station.

Optionally, the generating the internal coordinated dispatch plan for the hybrid energy storage power station using the niche-based gradient-directed evolution algorithm and the dispatch plan prediction model according to the charging and discharging power of the hybrid energy storage power station includes: generating a plurality of target charging powers and target discharging powers using a random function, with a maximum capacity of the hybrid energy storage power station as an upper limit, and generating corresponding dispatch scenarios according to the target charging powers and the target discharging powers; constructing an internal coordinated dispatch model for the hybrid energy storage power station with an objective of satisfying the charging power and the discharging power of the hybrid energy storage power station; solving the internal coordinated dispatch model for the hybrid energy storage power station using the niche-based gradient-directed evolution algorithm to obtain target dispatch plans under different dispatch scenarios; generating a neural network training dataset based on the target charging powers and target discharging powers of the hybrid energy storage power station, and the target dispatch plans under the corresponding dispatch scenarios as basic data; constructing the dispatch plan prediction model based on the CNN, the ISSA, and the BiGRU; training the dispatch plan prediction model using the neural network training dataset to obtain a trained dispatch plan prediction model; and inputting the charging and discharging power of the hybrid energy storage power station into the trained dispatch plan prediction model to obtain the internal coordinated dispatch plan for the hybrid energy storage power station.

Optionally, the hybrid energy storage power station includes an electrochemical energy storage system and a compressed air energy storage system; the target dispatch plan is a coordinated dispatch plan for the electrochemical energy storage system and the compressed air energy storage system within the hybrid energy storage power station.

Optionally, the electrochemical energy storage system includes a solenoid valve, a circulation pump, and a battery reactor; the compressed air energy storage system includes a compression unit, an expansion unit, an air storage tank, and a thermal storage tank; and the constructing the internal coordinated dispatch model for the hybrid energy storage power station with the objective of satisfying the charging power and the discharging power of the hybrid energy storage power station includes: constructing an electric energy loss model for the electrochemical energy storage system based on losses of the solenoid valve and the circulation pump and losses of the battery reactor; introducing a self-discharge rate coefficient based on a self-discharge problem that stored electric energy decreases after battery charging, and constructing an equivalent model for the electrochemical energy storage system; constructing an operational model for the compressed air energy storage system based on operating conditions of the compression unit, the expansion unit, the air storage tank, and the thermal storage tank; and constructing the internal coordinated dispatch model for the hybrid energy storage power station, with the objective of satisfying the charging power and the discharging power of the hybrid energy storage power station, and with the electric energy loss model for the electrochemical energy storage system, the equivalent model for the electrochemical energy storage system, the operational model for the compressed air energy storage system, and a relationship between the charging power and the discharging power as constraints.

Optionally, the relationship between the charging power and the discharging power is that a product of the charging power and the discharging power is equal to 0.

According to a second aspect, the present disclosure provides a computer device, including a memory, a processor, and a computer program stored in the memory and executable on the processor, where the processor executes the computer program to perform the method for coordinated dispatch of hybrid energy storage systems to adapt to peak loads in extreme scenarios.

According to the embodiments of the present disclosure, the present disclosure achieves the following technical effects: The present disclosure provides a method for coordinated dispatch of hybrid energy storage systems to adapt to peak loads in extreme scenarios, including: generating an extreme scenario set using a clustering algorithm for peak-valley difference characteristics according to wind power output, photovoltaic output, and electrical load data in a historical time period, which can overcome the problem of inconsistent results from traditional algorithms and ensure the effectiveness of the algorithm; generating an uncertainty set of extreme scenarios using a fast convex hull algorithm according to the wind power output, the photovoltaic output, and the electrical load data in the extreme scenario set, which can take into consideration the uncertainty factors within the extreme scenario set and improve the generation efficiency of the uncertainty set; generating, based on a general energy storage model in a SoC form, an aggregated model for the hybrid energy storage power station using a MOGNDO algorithm, which can accelerate the solution speed for multi-objective problems; constructing an intra-region robust optimization model for wind-photovoltaic-thermal-energy storage based on the aggregated model for the hybrid energy storage power station and the uncertainty set of extreme scenarios, and solving the intra-region robust optimization model for wind-photovoltaic-thermal-energy storage using a BKA to obtain a charging and discharging power of the hybrid energy storage power station, which can improve the global search capability and convergence speed of the algorithm; and generating an internal coordinated dispatch plan for the hybrid energy storage power station using a niche-based gradient-directed evolution algorithm and a dispatch plan prediction model according to the charging and discharging power of the hybrid energy storage power station, which can prevent premature convergence and falling into local solutions, enhance global search capability, and achieve rapid decision-making for the internal coordinated dispatch plan of the hybrid energy storage power station under extreme scenarios, thereby ensuring the stable supply capacity of the power grid under extreme scenarios.

### BRIEF DESCRIPTION OF THE DRAWINGS

To describe the technical solutions in the embodiments of the present disclosure or in the prior art more clearly, the drawings required for describing the embodiments are briefly described below. Apparently, the drawings in the following description show merely some embodiments of the present disclosure, and those of ordinary skill in the art may still derive other drawings from these drawings without creative efforts.

FIG. 1 is a main flowchart of a method for coordinated dispatch of hybrid energy storage systems to adapt to peak loads in extreme scenarios according to the present disclosure; and

FIG. 2 is a detailed schematic diagram of a method for coordinated dispatch of hybrid energy storage systems to adapt to peak loads in extreme scenarios according to the present disclosure.

### DETAILED DESCRIPTION OF THE EMBODIMENTS

The technical solutions in the embodiments of the present disclosure are clearly and completely described below with reference to the drawings in the embodiments of the present disclosure. Apparently, the described embodiments are only some rather than all of the embodiments of the present disclosure. All other embodiments obtained by a person of ordinary skill in the art based on the embodiments of the present disclosure without creative efforts shall fall within the protection scope of the present disclosure.

To make the above objectives, features, and advantages of the present disclosure more obvious and easy to understand, the present disclosure will be further described in detail with reference to the accompanying drawings and specific implementations.

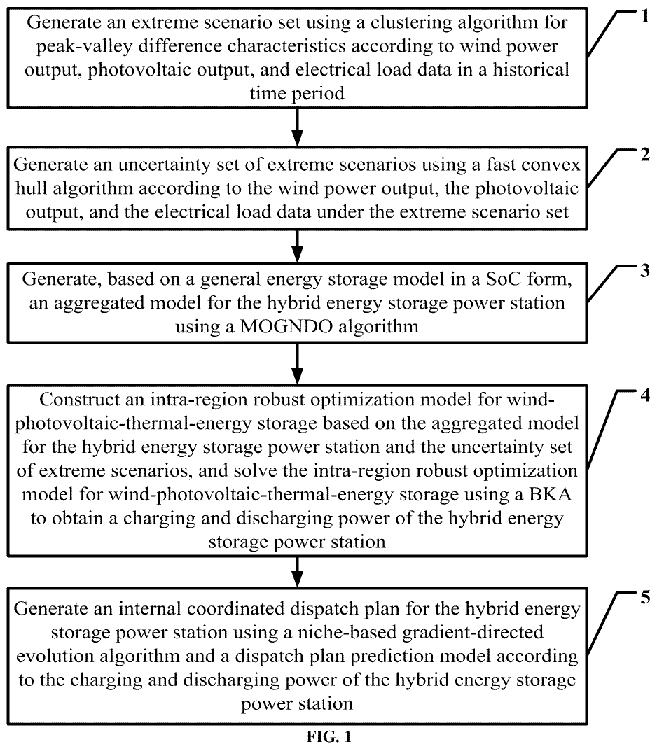

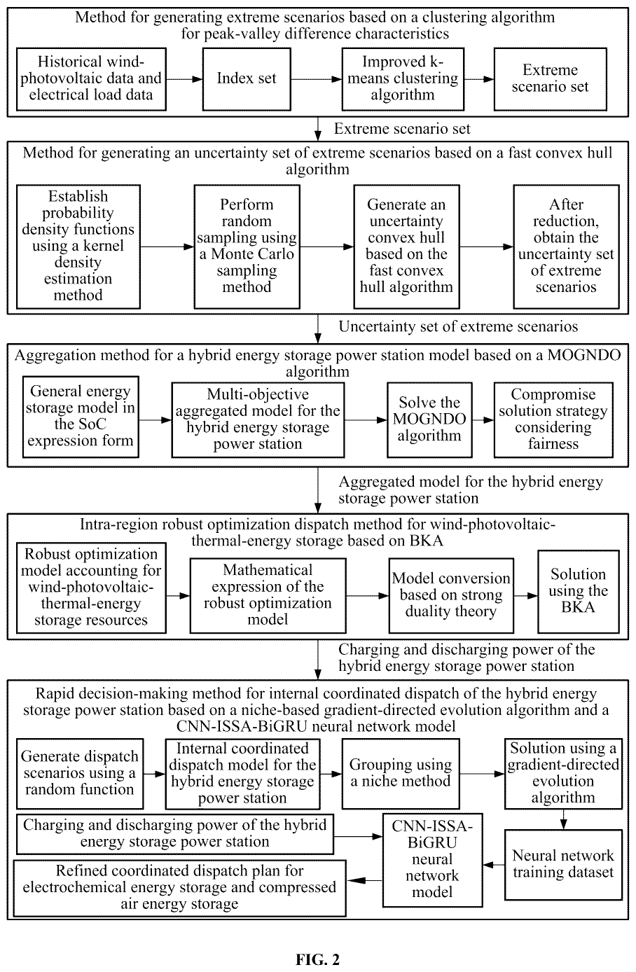

In an exemplary embodiment, the present disclosure provides a method for coordinated dispatch of hybrid energy storage systems to adapt to peak loads in extreme scenarios. As shown in FIG. 1 and FIG. 2, the method includes the following steps 1 to 5.

Step 1: Generate an extreme scenario set using a clustering algorithm for peak-valley difference characteristics according to wind power output, photovoltaic output, and electrical load data in a historical time period, specifically including the following steps 1-1 to 1-4.

Step 1-1: Acquire the wind power output, the photovoltaic output, and the electrical load data in the historical time period.

Step 1-2: Construct an index set of wind power characteristics, photovoltaic characteristics, and electrical load characteristics according to the wind power output, the photovoltaic output, and the electrical load data in the historical time period.

Wind power characteristic indexes and photovoltaic characteristic indexes both include maximum output peak-valley difference, average output, and maximum output fluctuation.

$$Δ {P}_{P}^{m ax} = {max}_{I \leq t \leq T} ( {P}_{P , t} ) - {min}_{1 \leq t \leq T} ( {P}_{P , t} ) \qquad ( 1 )$$

$${P}_{P}^{a v} = {\sum }_{t = 1}^{T} {P}_{P , t} / T \qquad ( 2 )$$

$$Δ {P}_{P}^{m i} = {max}_{1 \leq t \leq T - 1} \vert {P}_{P , t + 1} - {P}_{P , t} \vert \qquad ( 3 )$$

In the formulas:

$$Δ {P}_{P}^{m ax} , {P}_{P}^{a v} , and Δ {P}_{P}^{m i}$$

represent the maximum output peak-valley difference, average output, and maximum output fluctuation of wind power and photovoltaics; P_{P,t} represents output of wind power and photovoltaics in time period t; P_{P,t+1} represents output of wind power and photovoltaics in time period t+1; T is a total dispatch time period; max( ) represents taking a maximum value; and min( ) represents taking a minimum value.

Electrical load characteristic indexes include maximum load peak-valley difference, average load, and maximum load fluctuation.

$$Δ {P}_{L}^{ma x} = {max}_{1 \leq t \leq T} ( {P}_{L , t} ) - {min}_{1 \leq t \leq T} ( {P}_{L , t} ) \qquad ( 4 )$$

$${P}_{L}^{a v} = {\sum }_{t = 1}^{T} {P}_{L , t} / T \qquad ( 5 )$$

$$Δ {P}_{L}^{m i} = {max}_{1 \leq t \leq T - 1} \vert {P}_{L , t + 1} - {P}_{L , t} \vert \qquad ( 6 )$$

In the formulas,

$$Δ {P}_{L}^{m ax} , {P}_{L}^{a v} , and Δ {P}_{L}^{m i}$$

represent the maximum load peak-valley difference, average load, and maximum load fluctuation of the electrical load; P_{L,t} represents electrical load in time period t; and P_{L,t+1} represents electrical load in time period t+1.

Step 1-3: Perform clustering using an improved k-means clustering algorithm according to the index set of the wind power characteristics, the photovoltaic characteristics, and the electrical load characteristics, to obtain a cluster partitioning result. The improved k-means clustering algorithm, based on a k-means clustering algorithm, involves performing cluster partitioning of a full sample set by using a clustering result of a small sample set as an initial clustering center of the full sample set, to obtain the cluster partitioning result; the full sample set is the index set of the wind power characteristics, the photovoltaic characteristics, and the electrical load characteristics; and the small sample set is obtained by extracting a preset proportion from the full sample set. The preset proportion is preferably 10%.

Taking data within one day as a unit, one time period is represented by one data point, and on an hourly basis, one day can be divided into 24 time periods. During the clustering process, 10% of the full sample set is extracted to form the small sample set; then, the first clustering center in the small sample set is selected using a random method. Thereafter, samples farther from the clustering center have higher priority to be selected, which can ensure that during the selection process, points with more distinct features are selected as much as possible, ensuring that the clustering result reflects the characteristics of the original sample as much as possible, and guaranteeing the validity of the calculation result. The clustering result obtained from the small sample set is used as the initial clustering center of the full sample set, and then cluster partitioning of the full sample set is performed, overcoming the problem of inconsistent results obtained by the traditional k-means clustering algorithm.

A definition formula of a Euclidean distance based on the index set is as follows.

$${d}_{m n} = \sqrt{{( Δ {P}_{m}^{ma x} - Δ {P}_{n}^{m ax} )}^{2} + {( {P}_{m}^{a v} - {P}_{n}^{a v} )}^{2} + {( Δ {P}_{m}^{m i} - Δ {P}_{n}^{m i} )}^{2}} \qquad ( 7 )$$

In the formula, dₘₙ is a Euclidean distance between an m-th sample and an n-th sample;

$$Δ {P}_{m}^{ma x} and Δ {P}_{n}^{ma x}$$

are maximum peak-valley differences of the m-th sample and the n-th sample, respectively;

$${P}_{m}^{a v} and {P}_{n}^{a v}$$

are average values of the m-th sample and the n-th sample, respectively;

$$Δ {P}_{m}^{m i} and Δ {P}_{n}^{m i}$$

are maximum fluctuation values of the m-th sample and the n-th sample, respectively.

Euclidean distances between samples in each cluster and their clustering center is solved, ensuring that a sum of the Euclidean distances between the samples and their clustering center is minimized. After the cluster partitioning, samples assigned to the same cluster each have a Euclidean distance to their own clustering center that is smaller than distances to other clustering centers, and index characteristics of the samples in each cluster are similar.

Step 1-4: Generate the extreme scenario set according to the cluster partitioning result. Specifically, according to the cluster partitioning result, a scenario effect of samples in each group after clustering is calculated, and a group of samples with a maximum scenario effect is taken as the extreme scenario set.

According to the cluster partitioning result, the scenario effects of the samples after clustering are calculated using formula (8), and a group of samples with a maximum result is selected as the extreme scenario set.

$${D}_{RES} = \sqrt{\frac{{\sum }_{n = 1}^{{N}_{d}} [ {( Δ {P}_{n}^{m ax} )}^{2} + {( {P}_{n}^{a v} )}^{2} + {( Δ {P}_{n}^{m i} )}^{2} ]}{{N}_{d}}} \qquad ( 8 )$$

In the formula, D_{RES} represents a scenario effect; N_{d} is the number of samples in one group after clustering.

Step 2: Generate an uncertainty set of extreme scenarios using a fast convex hull algorithm according to the wind power output, the photovoltaic output, and the electrical load data in the extreme scenario set, specifically including the following steps 2-1 to 2-3.

Step 2-1: Construct probability density functions of wind power output, photovoltaic output, and electrical load under extreme scenarios using a kernel density estimation method according to the wind power output, the photovoltaic output, and the electrical load data in the extreme scenario set. The kernel density estimation method is preferably a non-parametric kernel density estimation method.

According to the wind power output, the photovoltaic output, and the electrical load data in the extreme scenario set, using the same time period as a benchmark, and using a Gaussian function as a kernel function, the probability density function of wind power output, the probability density function of photovoltaic output, and the probability density function of electrical load under extreme scenarios are established using the non-parametric kernel density estimation method.

$$\{ \begin{matrix}f ( {P}_{P V} ) = \frac{1}{N} {\sum }_{n = 1}^{N} {K}_{h} ( {P}_{P V} - {P}_{PV , n} ) \\ f ( {P}_{W T} ) = \frac{1}{N} {\sum }_{n = 1}^{N} {K}_{h} ( {P}_{W T} - {P}_{W T , n} ) \\ f ( {P}_{L} ) = \frac{1}{N} {\sum }_{n = 1}^{N} {K}_{h} ( {P}_{L} - {P}_{L , n} )\end{matrix} \qquad ( 9 )$$

In the formula, Kₕ is the Gaussian function; ƒ(P_{WT}), ƒ(P_{PV}), and ƒ(P_{L}) are the probability density function of wind power output, the probability density function of photovoltaic output, and the probability density function of electrical load, respectively; P_{WT} is wind power output; P_{WT,n} is wind power output under an n-th sample; P_{PV} is photovoltaic output; P_{PV,n} is photovoltaic output under the n-th sample; P_{L} is electrical load; P_{L,n} is electrical load under the n-th sample; N is the number of samples in the extreme scenario set.

Step 2-2: Perform random sampling using a Monte Carlo sampling method according to the probability density functions of wind power output, photovoltaic output, and electrical load under extreme scenarios, to generate a random scenario set.

Based on the above probability density functions, random sampling is performed using the Monte Carlo sampling method to generate random scenarios, constituting the random scenario set.

Step 2-3: Generate the uncertainty set of extreme scenarios using the fast convex hull algorithm according to the random scenario set.

Based on the random scenario set from the previous step, the uncertainty set of extreme scenarios is generated using the fast convex hull algorithm, i.e., three-dimensional uncertainty convex hull Uₜ at each time period.

$$( {P}_{PV , t} , {P}_{WT , t} , {P}_{L , t} ) ∈ {U}_{t} \qquad ( 10 )$$

In the formula, ∈ is an element-of symbol.

The specific implementation process of the fast convex hull algorithm is as follows: in the initialization phase, the algorithm scans all data points and selects four extreme points to construct an initial tetrahedron, removing points inside the tetrahedron. Thereafter, the remaining external points are processed iteratively; during iteration, internal points are deleted, and the remaining points in each face are reassigned to corresponding sub-faces. After the iteration is completed, a convex polyhedron can be obtained.

Simultaneously, to further simplify the uncertainty set convex hull, using the boundary points of the convex polyhedron as a candidate set, an 8-point, 6-face convex space is created to characterize the uncertainty set, and with the goal of maximizing spatial coverage, a simplified three-dimensional uncertainty convex hull Gₜ.

$${σ}_{t} = \frac{V ( {G}_{t} )}{V ( {U}_{t} )} \qquad ( 11 )$$

In the formula, σₜ is a spatial coverage rate in time period t. V(Uₜ) and V(Gₜ) are volumes of the three-dimensional uncertainty convex hull before and after simplification, respectively.

This method considers uncertainty factors within the interval of the extreme scenario set, comprehensively retains an uncertainty interval range by using a sampling method, comprehensively balances robustness and optimization benefits, and uses the fast convex hull optimization algorithm to improve the generation efficiency of the uncertainty set.

Step 3: Generate, based on a general energy storage model in a SoC form, an aggregated model for the hybrid energy storage power station using a MOGNDO algorithm, specifically including the following steps 3-1 to 3-3.

Step 3-1: Construct a multi-objective aggregated model for the hybrid energy storage power station based on the general energy storage model in the SoC form.

The aggregated model for the hybrid energy storage power station is constructed based on the general energy storage model in the SoC form. The general energy storage model in the SoC form is as follows.

$$\{ \begin{matrix}0 \leq {p}_{es , t}^{c} , {p}_{es , t}^{d} \leq {P}_{e s}^{N} \\ {p}_{es , t}^{c} \times {p}_{es , t}^{d} = 0 \\ S o {C}_{es , t} = S o {C}_{es , t - 1} + ( {η}_{e s}^{c} {p}_{es , t}^{c} - {p}_{es , t}^{d} / {η}_{e s}^{d} ) Δ t / {E}_{e s}^{N} \\ S o {C}_{e s}^{m i n} \leq S o {C}_{es , t} \leq S o {C}_{e s}^{m ax} \\ S o {C}_{es , 0} = S o {C}_{es , T}\end{matrix} \qquad ( 12 )$$

In the formula,

$${p}_{es , t}^{c} and {p}_{es , t}^{d}$$

represent a charging power and a discharging power of energy storage in time period t, respectively;

$${η}_{e s}^{c} and {η}_{e s}^{d}$$

are charging efficiency and discharging efficiency, respectively;

$${P}_{e s}^{N} and {E}_{e s}^{N}$$

are a rated capacity and rated energy of the energy storage, respectively; SOC_{es,t} is a SoC of the energy storage in time period t; SOC_{es,t-1} is a SoC of the energy storage in time period t−1;

$$S o {C}_{e s}^{m i n} and {SoC}_{es}^{m ax}$$

are a minimum SoC and a maximum SoC, respectively; SOC_{es,0} and SOC_{es,T} are a SoC at an initial moment and a SoC at a final moment, respectively; Δt represents a time interval.

During model aggregation of the hybrid energy storage power station, the objectives are to minimize an expected net load fluctuation and maximize a regulation capability of the energy storage power station. The operation of the electrochemical energy storage system and the compressed air energy storage system satisfies the above SoC constraints.

The objective function and constraints of the multi-objective problem (the multi-objective aggregated model for the hybrid energy storage power station) are as follows.

$$\{ \begin{matrix}min {L}_{e s} = {\sum }_{t = 1}^{T} {( {P}_{load , t}^{a v} - {P}_{PV , t}^{a v} - {P}_{WT , t}^{a v} - {p}_{all , t}^{d} + {p}_{all , t}^{c} )}^{2} \\ min ( - {P}_{e s} ) = - {\sum }_{t = 1}^{T} ( {P}_{a ll , t}^{m ax , c} + {P}_{a ll , t}^{m ax , d} ) \\ {p}_{all , t}^{c} = {p}_{ees , t}^{c} + {p}_{c aes , t}^{c} \\ {p}_{all , t}^{d} = {p}_{ees , t}^{d} + {p}_{c aes , t}^{d}\end{matrix} \qquad ( 13 )$$

$$( 14 )$$

$$\{ \begin{matrix}{P}_{a ll , t}^{ma x , c} \leq min ( {P}_{e e s}^{N} , \frac{( S o {C}_{e e s}^{m ax} - S o {C}_{ees , t - 1} ) {E}_{e e s}^{N}}{{η}_{e e s}^{c}} ) + min ( {P}_{c aes}^{N} , \frac{( S o {C}_{c a e s}^{ma x} - S o {C}_{c aes , t - 1} ) {E}_{c a e s}^{N}}{{η}_{c a e s}^{c}} ) \\ {P}_{a ll , t}^{m ax , d} \leq min ( {P}_{e e s}^{N} , ( So {C}_{ees , t - 1} - S o {C}_{e e s}^{m i n} ) {E}_{e e s}^{N} {η}_{e e s}^{d} ) + min ( {P}_{c a e s}^{N} , ( So {C}_{c aes , t - 1} - S o {C}_{c a e s}^{m i n} ) {E}_{c a e s}^{N} {η}_{e e s}^{d} ) \\ {P}_{a ll , t}^{ma x , d} \times {P}_{a ll , t}^{m ax , c} = 0 \\ Formula ( 12 )\end{matrix}$$

Formula (13) is an objective function of a multi-objective problem, including an expected net load fluctuation Lₑₛ and an energy storage power station regulation capability Pₑₛ; in formula (13),

$${P}_{load , t}^{av} , {P}_{WT , t}^{a v} and {P}_{PV , t}^{a v}$$

represent average output of electrical load, average output of wind power, and average output of photovoltaics in time period t, respectively, serving as input data;

$${p}_{all , t}^{c} and {p}_{all , t}^{d}$$

are a charging power and a discharging power of the energy storage power station in time period t, respectively;

$${P}_{a ll , t}^{max , c} and {P}_{a ll , t}^{max , d}$$

are a maximum charging capability and a maximum discharging capability of the energy storage power station in time period t, respectively;

$${p}_{ees , t}^{c} and {p}_{caes , t}^{c}$$

are a charging power of the electrochemical energy storage system and a charging power of the compressed air energy storage system in the energy storage power station in time period t; similarly,

$${p}_{ees , t}^{d} and {p}_{caes , t}^{d}$$

are corresponding discharging powers in time period t. In formula (14), ees characterizes the electrochemical energy storage system, and caes characterizes the compressed air energy storage system;

$${E}_{e e s}^{N} and {E}_{c a e s}^{N}$$

are a rated capacity of the electrochemical energy storage system and a rated capacity of the compressed air energy storage system, respectively;

$${η}_{e e s}^{c} and {η}_{c a e s}^{c}$$

are rated energy of the electrochemical energy storage system and rated energy of the compressed air energy storage system, respectively;

$${η}_{e e s}^{c}$$

and

$${η}_{c a e s}^{c}$$

are charging efficiency of the electrochemical energy storage system and charging efficiency of the compressed air energy storage system, respectively;

$${η}_{e e s}^{d} and {η}_{c a e s}^{d}$$

are discharging efficiency of the electrochemical energy storage system and discharging efficiency of the compressed air energy storage system, respectively; SOC_{ees,t-1} and SOC_{caes,t-1} are a SoC of the electrochemical energy storage system and a SoC of the compressed air energy storage system in time period t−1, respectively;

$$S o {C}_{e e s}^{min} and {SoC}_{c a e s}^{min}$$

are a minimum SoC of the electrochemical energy storage system and a minimum SoC of the compressed air energy storage system, respectively;

$$S o {C}_{e e s}^{max} and {SoC}_{c a e s}^{max}$$

are a maximum SoC of the electrochemical energy storage system and a maximum SoC of the compressed air energy storage system, respectively. The constraints in formula (14) incorporate the general energy storage model in the SoC form, as defined in formula (12).

Step 3-2: Solve the multi-objective aggregated model for the hybrid energy storage power station using the MOGNDO algorithm to obtain a Pareto optimal solution set.

To address the above multi-objective problem, a MOGNDO algorithm is used. This algorithm adds an Archive Mechanism (AM) to the generalized normal distribution optimization algorithm to store non-dominated Pareto optimal solutions, recording optimal results in detail; simultaneously, it introduces a Leader Selection Mechanism (LSM) that can identify and select the optimal solution from the archive to guide the optimization process.

Based on the Generalized Normal Distribution Optimization (GNDO) algorithm, exploration and exploitation are conducted to obtain the optimal solution. First, it is necessary to evaluate all populations through the objective function; further, for each solution in the population, generated random numbers are used to switch between an exploration mode and an exploitation mode. In a global exploration mode, the entire search space is scanned to identify potential regions. A local exploitation mode seeks improved solutions near existing positions of all individuals in the search space.

The exploration equation and the exploitation equation are shown in formula (15) and formula (16), respectively.

$${u}_{i}^{l} = {a}_{i}^{l} + α \times ( \vert {ε}_{1} \vert \times {u}_{1} ) + ( 1 - α ) \times ( \vert {ε}_{2} \vert \times {u}_{2} ) \qquad ( 15 )$$

$${u}_{i}^{l} = {μ}_{i} + {δ}_{i} \times θ \qquad ( 16 )$$

In the formulas,

$${u}_{i}^{l}$$

is a position to be updated; u₁ and u₂ are intermediate positions of decision variables;

$${a}_{i}^{l}$$

is a current optimal position; α is an adjustment parameter; ε₁ and ε₂ are random variables following a standard normal distribution; μᵢ represents a generalized mean position of an i-th individual; δᵢ represents a generalized standard deviation; and ϑ is a penalty factor.

Furthermore, an Archive Mechanism (AM) and a Leader Selection Mechanism (LSM) are introduced. The AM aims to save non-dominated solutions obtained so far, and includes an archive controller and a grid. The archive controller decides whether to include a solution in the archive. Solutions already existing in the archive are immediately excluded. The non-dominated solutions are added to the archive. When the archive reaches its capacity limit, the grid mechanism is activated; the role of the grid is to maintain the diversity of solutions in the archive as much as possible by dividing the space into multiple regions.

The LSM takes the optimal solution obtained so far as the current optimal position. This strategy utilizes archive information to select a leader from a less dense region in the search space and provides one of the non-dominated solutions as a new optimal position. The probability of each region proposing a new leader is detailed in formula (17), where the significance lies in that the search direction is constantly biased towards regions in the search space that have not been thoroughly explored or exposed.

$${P}_{w} = \frac{A}{{Y}_{w}} \qquad ( 17 )$$

In the formula, P_{w} is a probability of a w-th region proposing a new leader; A is a constant greater than 1; and Y_{w} is the number of obtained Pareto optimal solutions.

Step 3-3: Convert the multi-objective aggregated model for the hybrid energy storage power station using a compromise solution strategy considering fairness according to the Pareto optimal solution set, to generate the aggregated model for the hybrid energy storage power station.

The result obtained by the MOGNDO algorithm is a Pareto optimal solution set, but in practice, only one solution is needed. Finding a suitable solution from the Pareto optimal solution set is a multi-attribute decision-making problem. The present disclosure adopts a compromise solution strategy considering fairness to achieve multi-objective optimization decision-making, i.e., selecting a point where an incremental ratio is close to 1 as a fair compromise solution. The fairness of the Pareto solution set is defined as follows.

$$\{ \begin{matrix}Δ {L}_{e s} = \frac{{L}_{e s}}{{L}_{e s}^{min}} \\ Δ ( - {P}_{e s} ) = \frac{( - {P}_{e s} )}{{( - {P}_{e s} )}^{min}} \\ \frac{Δ {L}_{e s}}{Δ ( - {P}_{e s} )} \to 1\end{matrix} \qquad ( 18 )$$

In the formula, ΔLₑₛ and

$${L}_{e s}^{min}$$

are a net load fluctuation increment and its minimum value, respectively; Δ(−Pₑₛ) and (−Pₑₛ)^{min} are an energy storage power station regulation capability increment and its minimum value, respectively.

The final equivalent model for the hybrid energy storage power station in the SoC form is as follows.

$$\{ \begin{matrix}0 \leq {p}_{es , t}^{c} , {p}_{es , t}^{d} \leq ( {P}_{a ll , t}^{max , d} + {P}_{a ll , t}^{max , c} ) \\ So {C}_{es , C} = So {C}_{es , t - 1} + ( {η}_{e s}^{c} {p}_{es , t}^{c} - {p}_{est , t}^{d} / {η}_{e s}^{d} ) Δ t / ( {E}_{e e s}^{N} + {E}_{c a e s}^{N} ) \\ S o {C}_{e s}^{min} \leq S o {C}_{es , t} \leq S o {C}_{e s}^{max} \\ S o {C}_{e s , 0} = S o {C}_{e s , T}\end{matrix} \qquad ( 19 )$$

Step 4: Construct an intra-region robust optimization model for wind-photovoltaic-thermal-energy storage based on the aggregated model for the hybrid energy storage power station and the uncertainty set of extreme scenarios, and solve the intra-region robust optimization model for wind-photovoltaic-thermal-energy storage using a BKA to obtain a charging and discharging power of the hybrid energy storage power station, which specifically includes the following steps 4-1 to 4-4.

Step 4-1: Construct the intra-region robust optimization model for wind-photovoltaic-thermal-energy storage based on the aggregated model for the hybrid energy storage power station and the uncertainty set of extreme scenarios.

A robust optimization model considering intra-region wind-photovoltaic-thermal-energy storage resources is proposed. The robust optimization model accounting for wind-photovoltaic-thermal-energy storage resources is as follows.

$$\{ \begin{matrix}min F = min ( {F}^{g} + {F}^{n e w} + {F}^{e s} ) \\ {F}^{g} = {\sum }_{t = 1}^{T} ( {c}_{g} {p}_{g , t} Δ t ) \\ {F}^{n e w} = {\sum }_{t = 1}^{T} {c}_{n e w} ( {P}_{WT , t} + {P}_{PV , t} - {p}_{wt , t} - {p}_{pv , t} ) Δ t \\ {F}^{e s} = {\sum }_{t = 1}^{T} {c}_{es , t} ( {p}_{es , t}^{d} - {p}_{es , t}^{c} ) Δ t\end{matrix} \qquad ( 20 )$$

$$\{ \begin{matrix}{P}_{WT , t} + {P}_{PV , t} + {p}_{g , t} + {p}_{es , t}^{d} = {p}_{es , t}^{c} + {p}_{load , t} \\ {P}_{k a}^{min} \leq {p}_{ka , t} \leq {P}_{k a}^{max} \\ 0 \leq {P}_{wt , t} \leq {P}_{WT , t} \leq {P}_{wt}^{N} \\ 0 \leq {P}_{pv , t} \leq {P}_{PV , t} \leq {P}_{p v}^{N} \\ {α}_{min} {B}_{g , t} \leq {p}_{g , t} \leq {α}_{max} {B}_{g , t} \leq {P}_{g}^{N} \\ {p}_{g , t} - {p}_{g , t - 1} \leq {β}_{u p} {B}_{g , t} \\ {p}_{g , t - 1} - {p}_{g , t} \leq {β}_{d o w n} {B}_{g , t} \\ ( {P}_{PV , t} , {P}_{WT , t} , {P}_{L , t} ) ∈ {G}_{t} \\ Formula ( 19 )\end{matrix} \qquad ( 21 )$$

Formula (20) is an objective function of the intra-region robust optimization model for wind-photovoltaic-thermal-energy storage, where F, F^{g}, F^{new}, and F^{es} are a total cost, a coal consumption cost, a renewable energy curtailment cost, and an energy storage power station dispatch cost within an optimization dispatch period, respectively; p_{g,t}, p_{wt,t}, and p_{pv,t} are actual output of thermal power, actual output of wind power, and actual output of photovoltaics in time period t, respectively; p_{g,t-1} is actual output of thermal power in time period t−1; P_{WT,t} and P_{PV,t} are predicted output of wind power and predicted output of photovoltaics in time period t, respectively;

$${p}_{es , t}^{c} and {p}_{es , t}^{d}$$

are an actual charging power and an actual discharging power of the energy storage power station in time period t, respectively; c_{g} and c_{new} are a coal cost per unit of electricity and a penalty cost per unit of renewable energy curtailment, respectively; c_{es,t} is a time-of-use electricity price in time period t. Formula (21) expresses constraints of the intra-region robust optimization model for wind-photovoltaic-thermal-energy storage, where

$${P}_{g}^{N} , {P}_{wt}^{N} , and {P}_{p v}^{N}$$

are installed capacities of thermal power, wind power, and photovoltaics, respectively; B_{g,t} is a grid-connected capacity of thermal power in time period t; αₘᵢₙ, αₘₐₓ, βᵤₚ, and β_{down} are a minimum technical output coefficient, a maximum technical output coefficient, a ramp-up rate coefficient, and a ramp-down rate coefficient of thermal power, respectively; p_{ka,t} is an active power flow of a ka-th branch;

$${P}_{k a}^{min} and {P}_{k a}^{max}$$

are minimum and maximum active power flow limits of the ka-th branch, respectively; P_{load,t} is actual output of the electrical load in time period t. Formula (19) in formula (21) is the final equivalent model for the hybrid energy storage power station in the SoC form, i.e., the aggregated model for the hybrid energy storage power station.

Step 4-2: Convert the intra-region robust optimization model for wind-photovoltaic-thermal-energy storage into a max-min problem model.

The robust optimization model can be formulated as the following mathematical problem, i.e., the max-min problem model.

$$\{ \begin{matrix}{max}_{g ∈ G} {min}_{y ∈ Ω ( g )} ( {q}^{T} y ) \\ Dy \geq d \\ Hy = h \\ Ry = g\end{matrix} \qquad ( 22 )$$

$$y = [ {p}_{wt , t} , {p}_{pv , t} , {p}_{g , t} , {p}_{es , t}^{d} , {p}_{es , t}^{c} , {p}_{load , t} ] \qquad ( 23 )$$

In the formulas, G is an uncertainty set of wind power, photovoltaics, and electrical load; Ω(g) is a variable space related to g; y is a variable set; D is an inequality coefficient matrix; H is an equality coefficient matrix; R is an equality coefficient matrix related to wind power, photovoltaic, and electrical load uncertainty; q is an objective function coefficient vector; q^{T} is the transpose of q; d is an inequality coefficient vector; h is an equality coefficient vector; and g is an equality vector for wind power, photovoltaic, and electrical load uncertainty.

Step 4-3: Convert the max-min problem model into a single-layer max problem model using strong duality theory.

Furthermore, the robust optimization max-min problem is equivalently transformed into a single-layer max problem using strong duality theory.

$$\{ \begin{matrix}{max}_{g ∈ G , o , β , γ} ( {d}^{T} o + {h}^{T} β + {g}^{T} γ ) \\ {D}^{T} o + {H}^{T} β + {R}^{T} γ \leq q\end{matrix} \qquad ( 24 )$$

$$o , β , γ \geq 0$$

In the formula, o, β, and γ are the introduced dual variables; d^{T}, h^{T}, g^{T} D^{T}, H^{T}, and R^{T} are the transposes of d, h, g, D, H, and R, respectively.

Step 4-4: Solve the single-layer max problem model using the BKA to obtain the charging and discharging power of the hybrid energy storage power station.

The Black-winged Kite Algorithm (BKA) utilizes two models, attack behavior and migration behavior, for iterative optimization. The combined mode of the algorithm achieves a good balance between exploring global solutions and exploiting current information, improving the global search capability and convergence speed of the algorithm. Both attack behavior and migration behavior are divided into two strategies, as shown below.

$${x}_{b + 1}^{e , j} = \{ \begin{matrix}{x}_{b}^{e , j} + {h}_{a} ( 1 + sin ( {r}_{a} ) ) \times {x}_{b}^{e , j} , {p}_{a} < {r}_{a} \\ {x}_{b}^{e , j} + {h}_{a} ( 2 {r}_{a} - 1 ) \times {x}_{b}^{e , j} , else\end{matrix} \qquad ( 25 )$$

$${x}_{b + 1}^{e , j} = \{ \begin{matrix}{x}_{b}^{e , j} + C ( 0 , 1 ) \times ( {x}_{b}^{e , j} - {R}_{b}^{j} ) , {F}_{z} < {F}_{rz} \\ {x}_{b}^{e , j} + C ( 0 , 1 ) \times ( {R}_{b}^{j} - 2 sin ( {r}_{a} + π / 2 ) \times {x}_{b}^{e , j} ) , else\end{matrix} \qquad ( 26 )$$

In the formulas,

$${x}_{b}^{e , j}$$

is j-th dimensional position information of an e-th black-winged kite at a b-th iteration;

$${x}_{b + 1}^{e , j}$$

is j-th dimensional position information of the e-th black-winged kite at a (b+1)-th iteration; rₐ is a random number between 0 and 1; pₐ is a constant; hₐ is an iteration coefficient related to a current iteration count and a total number of iterations;

$${R}_{b}^{j}$$

represents j-th dimensional position information of a current optimal black-winged kite at the b-th iteration; F_{z} and F_{rz} represent fitness values of a j-th dimensional current position and a j-th dimensional random position obtained by any black-winged kite at the b-th iteration, respectively; C(0,1) represents Cauchy mutation.

The specific solution process for solving the transformed robust optimization model (single-layer max problem model) using the BKA is as follows: 1) initializing the population, i.e., assigning initial position information to each black-winged kite, where the position of one black-winged kite represents one solution of the model; 2) continuously updating the position of each black-winged kite using attack behavior and migration behavior strategies; 3) updating and recording current optimal black-winged kite position information and an objective value; 4) iterating continuously until a preset total number of iterations is reached, then ending the iteration, and completing the solution.

Step 5: Generate an internal coordinated dispatch plan for the hybrid energy storage power station using a niche-based gradient-directed evolution algorithm and a dispatch plan prediction model according to the charging and discharging power of the hybrid energy storage power station, specifically including the following steps 5-1 to 5-7. The dispatch plan prediction model is constructed based on a CNN, an ISSA, and a BiGRU.

Step 5-1: Generate a plurality of target charging powers and target discharging powers using a random function, with a maximum capacity of the hybrid energy storage power station as an upper limit, and generate corresponding dispatch scenarios according to the target charging powers and the target discharging powers.

Step 5-2: Construct an internal coordinated dispatch model for the hybrid energy storage power station with an objective of satisfying a charging power and a discharging power of the hybrid energy storage power station, specifically including the following steps 5-2-1 to 5-2-4. The hybrid energy storage power station includes an electrochemical energy storage system and a compressed air energy storage system. The electrochemical energy storage system includes a solenoid valve, a circulation pump, and a battery reactor. The compressed air energy storage system includes a compression unit, an expansion unit, an air storage tank, and a thermal storage tank.

Using the charging power and the discharging power of the hybrid energy storage power station from the previous step as boundaries, the internal coordinated dispatch model for the hybrid energy storage power station is established, where the hybrid energy storage power station includes the electrochemical energy storage system and the compressed air energy storage system.

Step 5-2-1: Construct an electric energy loss model for the electrochemical energy storage system based on losses of the solenoid valve and the circulation pump and losses of the battery reactor.

In the present disclosure, the electrochemical energy storage system includes batteries, and its electric energy loss includes losses from the operation of the solenoid valve and circulation pump as well as the battery reactor loss, as shown below.

$$\{ \begin{matrix}{e}_{t}^{D} = {\sum }_{o = 1}^{{N}_{D}} {u}_{o , t}^{D} ( {P}_{o}^{A} + {P}_{o}^{B} ) Δ t \\ {e}_{t}^{R c} = {η}^{R c} {\sum }_{o = 1}^{{N}_{D}} {u}_{o , t}^{D} {P}_{o}^{c} Δ t \\ {e}_{t}^{R d} = {η}^{R d} {\sum }_{o = 1}^{{N}_{D}} {u}_{o , t}^{D} {P}_{o}^{d} Δ t\end{matrix} \qquad ( 27 )$$

In the formula,

$${e}_{t}^{D}$$

is an electric energy loss of the solenoid valve and circulation pump in time period t;

$${P}_{o}^{A} and {P}_{o}^{B}$$

are a rated power of the solenoid valve and a rated power of the circulation pump of an o-th battery, respectively;

$${u}_{o , t}^{D}$$

is a startup state of the o-th battery in time period t; N_{D} is the number of batteries;

$${e}_{t}^{R c} and {e}_{t}^{R d}$$

are a charging electric energy loss and a discharging electric energy loss of the battery reactor in time period t, respectively;

$${η}^{R c} and {η}^{R d}$$

are charging efficiency and discharging efficiency of the battery reactor, respectively;

$${P}_{o}^{c} and {P}_{o}^{d}$$

are a charging rated power and a discharging rated power of the battery reactor of the o-th battery, respectively.

Step 5-2-2: Introduce a self-discharge rate coefficient based on a self-discharge problem that stored electric energy decreases after battery charging, and construct an equivalent model for the electrochemical energy storage system.

Considering the self-discharge problem that the stored electric energy decreases after battery charging, a self-discharge rate coefficient r_{d} is introduced, and an equivalent model for the electrochemical energy storage system is established as follows.

$$\{ \begin{matrix}{η}_{t}^{c} = [ 1 - ( \frac{{e}_{t}^{D} + {e}_{t}^{R c}}{{N}_{D} {E}_{D}^{N}} + {r}_{d} ) ] \times 100 \% \\ {η}_{t}^{d} = [ 1 - ( \frac{{e}_{t}^{D} + {e}_{t}^{R d}}{{N}_{D} {E}_{D}^{N}} ) ] \times 100 \%\end{matrix} \qquad ( 28 )$$

$$\{ \begin{matrix}{p}_{B , t}^{c} = {\sum }_{o = 1}^{{N}_{D}} {u}_{o , t}^{D} {P}_{o}^{c} \\ {p}_{B , t}^{d} = {\sum }_{o = 1}^{{N}_{D}} {u}_{o , t}^{D} {P}_{o}^{d} \\ {E}_{B , t} = {E}_{B , t - 1} + {η}_{t}^{c} {p}_{B , t}^{c} Δ t - {p}_{B , t}^{d} Δ t / {η}_{t}^{d} \\ S o {C}_{B}^{min} {N}_{D} {E}_{D}^{N} \leq {E}_{B , t} \leq S o {C}_{B}^{max} {N}_{D} {E}_{D}^{N}\end{matrix} \qquad ( 29 )$$

In formula (28),

$${η}_{t}^{c} and {η}_{t}^{d}$$

are equivalent charging efficiency and discharging efficiency of the electrochemical energy storage system in time period t, respectively;

$${E}_{D}^{N}$$

is rated energy of the battery reactor. In formula (29),

$${p}_{B , t}^{c} and {p}_{B , t}^{d}$$

are an equivalent charging power and discharging power of the electrochemical energy storage system in time period t, respectively; E_{B,t} is an energy status of the electrochemical energy storage system in time period t; E_{B,t-1} is an energy status of the electrochemical energy storage system in time period t−1;

$${SoC}_{B}^{min} and {SoC}_{B}^{max}$$

are a minimum SoC and a maximum SoC of the electrochemical energy storage system, respectively.

Step 5-2-3: Construct an operational model for the compressed air energy storage system based on operating conditions of the compression unit, the expansion unit, the air storage tank, and the thermal storage tank.

In the present disclosure, the compressed air energy storage system mainly includes a compression unit, an expansion unit, an air storage tank, and a thermal storage tank. The operational model is as follows.

$$\{ \begin{matrix}{p}_{A , t}^{c} = {k}_{c} {\dot{m}}_{c , t} \\ {p}_{A , t}^{d} = {k}_{d} {\dot{m}}_{d , t} \\ {P}_{st , t} = {p}_{st , 0} + {\sum }_{τ = 1}^{t} ( {k}_{c} {p}_{A , τ}^{c} - {k}_{d} {p}_{A , τ}^{d} ) Δ τ \\ {h}_{hs , t} = {h}_{hs , 0} + {\sum }_{τ = 1}^{t} ( {h}_{A , τ}^{c} - {h}_{A , τ}^{d} - {h}_{A , τ}^{st} ) Δτ\end{matrix} \qquad ( 30 )$$

$$\{ \begin{matrix}{h}_{A , t}^{out} = {k}_{st} {h}_{A , t}^{st} \\ 0 \leq {h}_{A , t}^{st} \leq {H}_{max}^{st} \\ {H}_{min}^{h s} \leq {h}_{hs , t} \leq {H}_{max}^{h s} \\ {P}_{min}^{st} \leq {p}_{st , t} \leq {P}_{max}^{st}\end{matrix} \qquad ( 31 )$$

In formula (30),

$${p}_{A , t}^{c} and {p}_{A , t}^{d}$$

are a charging power and a discharging power of the compressed air energy storage system in time period t, respectively;

$${p}_{A , τ}^{c} and {p}_{A , τ}^{d}$$

are a charging power and a discharging power of the compressed air energy storage system in time period r, respectively; k_{c} and k_{d} are a compression charging coefficient and an expansion discharging coefficient, respectively; \dot{m}_{c,t} and \dot{m}_{d,t} are a gas mass flow rate into and a gas mass flow rate out of the air storage tank in time period t, respectively; p_{st,0} and p_{st,t} are air pressure values of the air storage tank at an initial moment and at time period t, respectively; h_{hs,0} and h_{hs,t} are internal heat of the thermal storage tank at the initial moment and at time period t, respectively;

$${h}_{A , τ}^{c} and {h}_{A , τ}^{d}$$

are a power of heat storage during compression and a power of heat utilization during expansion in time period τ, respectively;

$${h}_{A , τ}^{st}$$

is an output thermal power of the thermal storage tank in time period τ; Δτ is a minimum dispatch period. In formula (31), kₛₜ is a thermal energy loss coefficient;

$${h}_{A , t}^{st}$$

is an output thermal power of the thermal storage tank in time period t;

$${h}_{A , t}^{out}$$

is an actual output thermal power taking losses into consideration in time period t;

$${H}_{max}^{st}$$

is an upper limit of the output thermal power;

$${H}_{min}^{hs} and {H}_{max}^{hs}$$

are lower and upper limits of the heat in the thermal storage tank, respectively;

$${P}_{min}^{st} and {P}_{max}^{st}$$

are lower and upper limits of the air pressure in the air storage tank, respectively.

Step 5-2-4: Construct the internal coordinated dispatch model for the hybrid energy storage power station, with the objective of satisfying the charging power and the discharging power of the hybrid energy storage power station, and with the electric energy loss model for the electrochemical energy storage system, the equivalent model for the electrochemical energy storage system, the operational model for the compressed air energy storage system, and a relationship between the charging power and the discharging power as constraints. The relationship between the charging power and the discharging power is that a product of the charging power and the discharging power is equal to 0.

The internal coordinated dispatch model for the hybrid energy storage power station aims to satisfy the charging power and discharging power of the hybrid energy storage power station, and the problem can be expressed as follows.

$$\{ \begin{matrix}min f = min {\sum }_{c = 1}^{T} [ {( {P}_{es , t}^{c} - {p}_{A , t}^{c} - {p}_{B , t}^{c} )}^{2} + {( {P}_{es , t}^{d} - {p}_{A , t}^{d} - {p}_{B , t}^{d} )}^{2} ] \\ Formulas ( 27 - 31 ) \\ {P}_{es , t}^{c} \times {P}_{es , t}^{d} = 0\end{matrix} \qquad ( 32 )$$

In the formula, ƒ is an objective function of the internal coordinated dispatch model for the hybrid energy storage power station;

$${P}_{es , t}^{c} and {P}_{es , t}^{d}$$

are a target charging power and a target discharging power of the hybrid energy storage power station in the time period t, respectively; formulas (27-31) in formula (32) are the electric energy loss model for the electrochemical energy storage system, the equivalent model for the electrochemical energy storage system, and the operational model for the compressed air energy storage system, respectively.

Step 5-3: Solve the internal coordinated dispatch model for the hybrid energy storage power station using the niche-based gradient-directed evolution algorithm to obtain target dispatch plans under different dispatch scenarios. The target dispatch plan is a coordinated dispatch plan for the electrochemical energy storage system and the compressed air energy storage system within the hybrid energy storage power station.

For the above minimization optimization problem, a niche-based gradient-directed evolution algorithm is used for solution. This algorithm utilizes gradient information to guide the mutation direction and adopts a niche method to protect population diversity, preventing premature convergence and falling into local solutions, thereby enhancing the global search capability.

The specific solution process is as follows: First, the population is initialized using random numbers, with a population size of M. Second, the niche method is used to divide the population into multiple groups according to fitness values of individuals, where the number of individuals in each group is given by formula (33), thereby maintaining population diversity. Third, based on formulas (34)-(35), iteration is performed on each niche group by using a mutation operator, to obtain candidate individuals, and at the same time, the individuals are updated according to formula (36). Finally, iteration is performed continuously until the upper limit of iterations is reached, obtaining the global optimal solution. That is, a refined coordinated dispatch plan for the electrochemical energy storage system and the compressed air energy storage system within the hybrid energy storage power station under the target of satisfying charging and discharging of the hybrid energy storage power station is obtained.

$${z}_{υ} = \{ \begin{matrix}z , & υ = 1 , … , ⌈ M / z ⌉ - 1 \\ M - z \cdot ( ⌈ M / z ⌉ - 1 ) , & υ = ⌈ M / z ⌉\end{matrix} \qquad ( 33 )$$

$${p}_{υ , φ}^{k} = \frac{f ( {x}_{υ , φ}^{k} ) - {f}_{υ , min}}{{f}_{υ , max} - {f}_{υ , min}} \qquad ( 34 )$$

$${\overline{x}}_{υ , φ}^{k + 1} = \{ \begin{matrix}{x}_{υ , φ}^{k} - {κ}_{k} {g}_{υ , φ}^{k} + {H}_{b} ( {x}_{υ , best}^{k} - {x}_{υ , φ}^{k} ) , & {p}_{υ , φ}^{k} \leq {p}_{h} \\ {x}_{υ , φ}^{k} + H ( {x}_{2} - {x}_{1} ) , & else\end{matrix} \qquad ( 35 )$$

$${x}_{υ , φ}^{k + 1} = \{ \begin{matrix}{\overline{x}}_{υ , φ}^{k + 1} , & f ( {\overline{x}}_{υ , φ}^{k + 1} ) \leq f ( {m}_{υ , φ}^{k} ) \\ {m}_{υ , φ}^{k} , & else\end{matrix} \qquad ( 36 )$$

In the formulas, M is a total population size; z_{ν} is the number of individuals in a ν-th niche; z is a constant; ƒ_{ν,max} and ƒ_{ν,min} are a maximum value and a minimum value of individuals in a ν-th group, respectively;

$$f ( {x}_{υ , φ}^{k} ) and {p}_{υ , φ}^{k}$$

are an objective function value and a standardized function value of a φ-th individual in the ν-th group, respectively; pₕ is a constant between 0 and 1;

$${\overline{x}}_{υ , φ}^{k + 1}$$

is a candidate individual at a (k+1)-th iteration;

$${x}_{υ , φ}^{k} and {g}_{υ , φ}^{k}$$

are a position and gradient of the φ-th individual in the ν-th group at the k-th iteration, respectively;

$${x}_{υ , best}^{k}$$

is a position of an optimal individual in the ν-th group at the k-th iteration; H_{b} is a mutation factor; κₖ is a step size; x₁ and x₂ are two individuals randomly selected from the total population;

$${m}_{υ , φ}^{k}$$

is an individual in the ν-th group at the k-th iteration closest to

$${\overline{x}}_{υ , φ}^{k + 1} .$$

Step 5-4: Generate a neural network training dataset based on the target charging powers and target discharging powers of the hybrid energy storage power station, and the target dispatch plans under the corresponding dispatch scenarios as basic data.

Step 5-5: Construct the dispatch plan prediction model based on the CNN, the ISSA, and the BiGRU.

Step 5-6: Train the dispatch plan prediction model using the neural network training dataset to obtain a trained dispatch plan prediction model.

Step 5-7: Input the charging and discharging power of the hybrid energy storage power station into the trained dispatch plan prediction model to obtain the internal coordinated dispatch plan for the hybrid energy storage power station.

A CNN-ISSA-BiGRU neural network model adapted for rapid decision-making in the dispatch for hybrid energy storage power stations is established. The specific process is as follows.

In the first step, using a maximum capacity of the hybrid energy storage power station as the upper limit, a large number of target charging powers and target discharging powers are generated using a random function. Furthermore, according to the principle that the product of the target charging power and the target discharging power is 0, either the target charging power or the target discharging power is set to zero randomly, thereby generating a large number of dispatch scenarios concerning the target charging powers and target discharging powers of the hybrid energy storage power station. Then, dispatch plans for the electrochemical energy storage system and the compressed air energy storage system within the hybrid energy storage power station under these dispatch scenarios are calculated using the niche-based gradient-directed evolution algorithm. Further, using the target charging powers and target discharging powers of the hybrid energy storage power station and the refined coordinated dispatch plans for the electrochemical energy storage system and the compressed air energy storage system within the hybrid energy storage power station as basic data, a neural network training dataset is generated.

In the second step, a CNN-ISSA-BiGRU neural network model is established to serve as a dispatch plan prediction model. In this model, a CNN layer serves as a data processing layer to preprocess the input data; an ISSA layer is used to search for optimal parameters of a BiGRU layer; and the BiGRU layer deeply analyzes the correlations between the data. The ISSA adopts a reverse learning strategy aimed at mitigating the impact of unpredictable trends in complex functions, addressing the shortcomings of low convergence accuracy and potential tendency towards local optima when dealing with complex function optimization problems.

In the third step, the neural network training dataset, as input data, is input into the CNN-ISSA-BiGRU neural network model, for training the model continuously. After the training is completed, a finished neural network model is obtained, i.e., the trained dispatch plan prediction model. The effect is that by inputting the target charging power and target discharging power of the hybrid energy storage power station into the finished neural network model, the refined coordinated dispatch plan for the electrochemical energy storage system and the compressed air energy storage system within the hybrid energy storage power station, i.e., the internal coordinated dispatch plan for the hybrid energy storage power station, can be quickly obtained.

The present disclosure proposes a method for coordinated dispatch of hybrid energy storage systems to adapt to peak loads in extreme scenarios. First, a k-means clustering algorithm for peak-valley difference characteristics is used to generate an extreme scenario set. Second, a kernel density estimation method is used to generate probability density functions under extreme scenarios; using sampled data, an uncertainty convex space is generated based on a fast convex hull algorithm and then reduced to form an uncertainty set of extreme scenarios. Third, based on a general energy storage model in the SoC form, a MOGNDO algorithm is used to generate an aggregated model for the hybrid energy storage power station. Fourth, an intra-region robust optimization model for wind-photovoltaic-thermal-energy storage (hybrid energy storage power station) is proposed, and solved using the BKA to obtain a robust optimization dispatch strategy (charging and discharging power of the hybrid energy storage power station). Finally, based on the output boundaries of the hybrid energy storage power station, a method for internal coordinated dispatch of the hybrid energy storage power station considering the niche-based gradient-directed evolution algorithm is proposed, and a CNN-ISSA-BiGRU neural network model is used to achieve rapid decision-making for the internal coordinated dispatch plan of the hybrid energy storage power station.

The technical effects of the present disclosure are as follows: (1) The clustering algorithm for peak-valley difference characteristics proposed in the present disclosure is suitable for the rapid screening of the extreme scenario set, and the clustering algorithm overcomes the problem of inconsistent results from traditional algorithms, stabilizing the algorithm effectiveness. (2) The present disclosure uses the fast convex hull algorithm to quickly convert the random scenario set into a three-dimensional uncertainty convex hull, which is then reduced to form the uncertainty set of extreme scenarios. This comprehensively retains the uncertainty interval range, balances robustness and optimization benefits, improves the generation efficiency of the uncertainty set, and also simplifies the complexity of the uncertainty set. (3) The present disclosure uses the MOGNDO algorithm to quickly solve the multi-objective aggregated model for the hybrid energy storage power station, accelerating the solution speed for multi-objective problems and rapidly generating the aggregated model for the hybrid energy storage power station. (4) The present disclosure uses strong duality theory to convert the intra-region robust optimization model for wind-photovoltaic-thermal-energy storage (hybrid energy storage power station), solving the problem of difficulty in solution under the uncertainty set, and uses the BKA to achieve rapid solution. The combined mode of the algorithm achieves a good balance between exploring global solutions and exploiting current information, improving the global search capability and convergence speed of the algorithm. (5) The internal coordinated dispatch model for the hybrid energy storage power station proposed in the present disclosure can support the charging and discharging power of the energy storage power station. The model is solved using the niche-based gradient-directed evolution algorithm, which utilizes gradient information to guide the mutation direction and adopts a niche method to protect population diversity, preventing premature convergence and falling into local solutions, thereby enhancing the global search capability. Furthermore, the CNN-ISSA-BiGRU neural network model is used to achieve rapid decision-making for the internal coordinated dispatch plan of the hybrid energy storage power station.

In an embodiment, a computer device is provided, including a memory and a processor, where the memory stores a computer program, and the computer program is executed by the processor to implement the steps of the above method embodiment.

In an embodiment, a computer-readable storage medium is provided. The computer-readable storage medium stores a computer program, and the computer program is executed by a processor to implement the steps of the above method embodiment.

In an embodiment, a computer program product is provided. The computer program product includes a computer program, and the computer program is executed by a processor to implement the steps of the above method embodiment.

In this application, the signals, information, or data are acquired in compliance with the relevant data protection regulations and policies of the respective country with the authorization of the respective device owner. It is to be noted that the information of a user (including but not limited to device information of the user, personal information of the user and the like) and data (including but not limited to data for analysis, data for storage, data for exhibition and the like) in the present disclosure are information and data authorized by the user or fully authorized by each party, and the information and data are acquired, used and processed according to relevant regulations.

Those of ordinary skill in the art may understand that all or some of the procedures in the method of the foregoing embodiments may be implemented by a computer program instructing related hardware. The computer program may be stored in a nonvolatile computer-readable storage medium. When the computer program is executed, the procedures in the embodiments of the foregoing method may be performed. Any reference to a memory, a database, or other media used in the embodiments of the present application may include a non-volatile and/or volatile memory. The nonvolatile memory may include a read-only memory (ROM), a magnetic tape, a floppy disk, a flash memory, an optical memory, a high-density embedded nonvolatile memory, a resistive random access memory (ReRAM), a magnetoresistive random access memory (MRAM), a ferroelectric random access memory (FRAM), a phase change memory (PCM), a graphene memory, etc. The volatile memory may include a random access memory (RAM) or an external cache memory. As an illustration rather than a limitation, the RAM may be in various forms, such as a static random access memory (SRAM) or a dynamic random access memory (DRAM).

The database in the embodiments of the present disclosure may include at least one of a relational database and a non-relational database. The non-relational database may include a distributed database based on a blockchain, but is not limited thereto. The processor in the embodiments of the present disclosure may be a general processor, a central processor, a graphics processor, a digital signal processor (DSP), a programmable logic device, and a data processing logic device based on quantum computing, but is not limited thereto.

The technical characteristics of the above embodiments can be employed in arbitrary combinations. To provide a concise description of these embodiments, all possible combinations of all the technical characteristics of the above embodiments may not be described; however, these combinations of the technical characteristics should be construed as falling within the scope defined by the specification as long as no contradiction occurs.

Several examples are used herein for illustration of the principles and implementations of this application. The description of the foregoing examples is used to help illustrate the method of this application and the core principles thereof. In addition, those of ordinary skill in the art can make various modifications in terms of specific implementations and scope of application in accordance with the teachings of this application. In conclusion, the content of the present specification shall not be construed as a limitation to this application.

What is claimed is:

1. A method for coordinated dispatch of hybrid energy storage systems to adapt to peak loads in extreme scenarios, applied to a hybrid energy storage power station, comprising:
generating an extreme scenario set using a clustering algorithm for peak-valley difference characteristics according to wind power output, photovoltaic output, and electrical load data in a historical time period;
generating an uncertainty set of extreme scenarios using a fast convex hull algorithm according to the wind power output, the photovoltaic output, and the electrical load data in the extreme scenario set;
generating, based on a general energy storage model in a State of Charge (SoC) form, an aggregated model for the hybrid energy storage power station using a multi-objective generalized normal distribution optimization (MOGNDO) algorithm;
constructing an intra-region robust optimization model for wind-photovoltaic-thermal-energy storage based on the aggregated model for the hybrid energy storage power station and the uncertainty set of extreme scenarios, and solving the intra-region robust optimization model for wind-photovoltaic-thermal-energy storage using a Black-winged Kite Algorithm (BKA) to obtain a charging and discharging power of the hybrid energy storage power station; and
generating an internal coordinated dispatch plan for the hybrid energy storage power station using a niche-based gradient-directed evolution algorithm and a dispatch plan prediction model according to the charging and discharging power of the hybrid energy storage power station, wherein the dispatch plan prediction model is constructed based on a Convolutional Neural Network (CNN), an improved Sparrow Search Algorithm (ISSA), and a Bidirectional Gated Recurrent Unit (BiGRU).

2. The method for coordinated dispatch of hybrid energy storage systems to adapt to peak loads in extreme scenarios according to claim 1, wherein the generating the extreme scenario set using the clustering algorithm for peak-valley difference characteristics according to the wind power output, the photovoltaic output, and the electrical load data in the historical time period comprises:
acquiring the wind power output, the photovoltaic output, and the electrical load data in the historical time period;
constructing an index set of wind power characteristics, photovoltaic characteristics, and electrical load characteristics according to the wind power output, the photovoltaic output, and the electrical load data in the historical time period;
performing clustering using an improved k-means clustering algorithm according to the index set of the wind power characteristics, the photovoltaic characteristics, and the electrical load characteristics, to obtain a cluster partitioning result, wherein the improved k-means clustering algorithm, based on a k-means clustering algorithm, involves performing cluster partitioning of a full sample set by using a clustering result of a small sample set as an initial clustering center of the full sample set, to obtain the cluster partitioning result; the full sample set is the index set of the wind power characteristics, the photovoltaic characteristics, and the electrical load characteristics; and the small sample set is obtained by extracting a preset proportion from the full sample set; and
generating the extreme scenario set according to the cluster partitioning result.

3. The method for coordinated dispatch of hybrid energy storage systems to adapt to peak loads in extreme scenarios according to claim 1, wherein the generating the uncertainty set of extreme scenarios using the fast convex hull algorithm according to the wind power output, the photovoltaic output, and the electrical load data in the extreme scenario set comprises:
constructing probability density functions of wind power output, photovoltaic output, and electrical load under extreme scenarios using a kernel density estimation method according to the wind power output, the photovoltaic output, and the electrical load data in the extreme scenario set;
performing random sampling using a Monte Carlo sampling method according to the probability density functions of wind power output, photovoltaic output, and electrical load under extreme scenarios, to generate a random scenario set; and
generating the uncertainty set of extreme scenarios using the fast convex hull algorithm according to the random scenario set.

4. The method for coordinated dispatch of hybrid energy storage systems to adapt to peak loads in extreme scenarios according to claim 1, wherein the generating, based on the general energy storage model in the SoC form, the aggregated model for the hybrid energy storage power station using the MOGNDO algorithm comprises:
constructing a multi-objective aggregated model for the hybrid energy storage power station based on the general energy storage model in the SoC form;
solving the multi-objective aggregated model for the hybrid energy storage power station using the MOGNDO algorithm to obtain a Pareto optimal solution set; and
converting the multi-objective aggregated model for the hybrid energy storage power station using a compromise solution strategy considering fairness according to the Pareto optimal solution set, to generate the aggregated model for the hybrid energy storage power station.

5. The method for coordinated dispatch of hybrid energy storage systems to adapt to peak loads in extreme scenarios according to claim 1, wherein the constructing the intra-region robust optimization model for wind-photovoltaic-thermal-energy storage based on the aggregated model for the hybrid energy storage power station and the uncertainty set of extreme scenarios, and solving the intra-region robust optimization model for wind-photovoltaic-thermal-energy storage using the BKA to obtain the charging and discharging power of the hybrid energy storage power station comprises:
constructing the intra-region robust optimization model for wind-photovoltaic-thermal-energy storage based on the aggregated model for the hybrid energy storage power station and the uncertainty set of extreme scenarios;
converting the intra-region robust optimization model for wind-photovoltaic-thermal-energy storage into a max-min problem model;
converting the max-min problem model into a single-layer max problem model using strong duality theory; and
solving the single-layer max problem model using the BKA to obtain the charging and discharging power of the hybrid energy storage power station.

6. The method for coordinated dispatch of hybrid energy storage systems to adapt to peak loads in extreme scenarios according to claim 1, wherein the generating the internal coordinated dispatch plan for the hybrid energy storage power station using the niche-based gradient-directed evolution algorithm and the dispatch plan prediction model according to the charging and discharging power of the hybrid energy storage power station comprises:
generating a plurality of target charging powers and target discharging powers using a random function, with a maximum capacity of the hybrid energy storage power station as an upper limit, and generating corresponding dispatch scenarios according to the target charging powers and the target discharging powers;
constructing an internal coordinated dispatch model for the hybrid energy storage power station with an objective of satisfying the charging power and the discharging power of the hybrid energy storage power station;
solving the internal coordinated dispatch model for the hybrid energy storage power station using the niche-based gradient-directed evolution algorithm to obtain target dispatch plans under different dispatch scenarios;
generating a neural network training dataset based on the target charging powers and target discharging powers of the hybrid energy storage power station, and the target dispatch plans under the corresponding dispatch scenarios as basic data;
constructing the dispatch plan prediction model based on the CNN, the ISSA, and the BiGRU;
training the dispatch plan prediction model using the neural network training dataset to obtain a trained dispatch plan prediction model; and
inputting the charging and discharging power of the hybrid energy storage power station into the trained dispatch plan prediction model to obtain the internal coordinated dispatch plan for the hybrid energy storage power station.

7. The method for coordinated dispatch of hybrid energy storage systems to adapt to peak loads in extreme scenarios according to claim 6, wherein the hybrid energy storage power station comprises an electrochemical energy storage system and a compressed air energy storage system; the target dispatch plan is a coordinated dispatch plan for the electrochemical energy storage system and the compressed air energy storage system within the hybrid energy storage power station.

8. The method for coordinated dispatch of hybrid energy storage systems to adapt to peak loads in extreme scenarios according to claim 7, wherein the electrochemical energy storage system comprises a solenoid valve, a circulation pump, and a battery reactor; the compressed air energy storage system comprises a compression unit, an expansion unit, an air storage tank, and a thermal storage tank; and the constructing the internal coordinated dispatch model for the hybrid energy storage power station with the objective of satisfying the charging power and the discharging power of the hybrid energy storage power station comprises:
constructing an electric energy loss model for the electrochemical energy storage system based on losses of the solenoid valve and the circulation pump and losses of the battery reactor;
introducing a self-discharge rate coefficient based on a self-discharge problem that stored electric energy decreases after battery charging, and constructing an equivalent model for the electrochemical energy storage system;
constructing an operational model for the compressed air energy storage system based on operating conditions of the compression unit, the expansion unit, the air storage tank, and the thermal storage tank; and
constructing the internal coordinated dispatch model for the hybrid energy storage power station, with the objective of satisfying the charging power and the discharging power of the hybrid energy storage power station, and with the electric energy loss model for the electrochemical energy storage system, the equivalent model for the electrochemical energy storage system, the operational model for the compressed air energy storage system, and a relationship between the charging power and the discharging power as constraints.

9. The method for coordinated dispatch of hybrid energy storage systems to adapt to peak loads in extreme scenarios according to claim 8, wherein the relationship between the charging power and the discharging power is that a product of the charging power and the discharging power is equal to 0.

10. A computer device, comprising a memory, a processor, and a computer program stored in the memory and executable on the processor, wherein the processor executes the computer program to implement the method for coordinated dispatch of hybrid energy storage systems to adapt to peak loads in extreme scenarios according to claim 1.

11. The computer device according to claim 10, wherein the generating the extreme scenario set using the clustering algorithm for peak-valley difference characteristics according to the wind power output, the photovoltaic output, and the electrical load data in the historical time period comprises:
acquiring the wind power output, the photovoltaic output, and the electrical load data in the historical time period;
constructing an index set of wind power characteristics, photovoltaic characteristics, and electrical load characteristics according to the wind power output, the photovoltaic output, and the electrical load data in the historical time period;
performing clustering using an improved k-means clustering algorithm according to the index set of the wind power characteristics, the photovoltaic characteristics, and the electrical load characteristics, to obtain a cluster partitioning result, wherein the improved k-means clustering algorithm, based on a k-means clustering algorithm, involves performing cluster partitioning of a full sample set by using a clustering result of a small sample set as an initial clustering center of the full sample set, to obtain the cluster partitioning result; the full sample set is the index set of the wind power characteristics, the photovoltaic characteristics, and the electrical load characteristics; and the small sample set is obtained by extracting a preset proportion from the full sample set; and
generating the extreme scenario set according to the cluster partitioning result.

12. The computer device according to claim 10, wherein the generating the uncertainty set of extreme scenarios using the fast convex hull algorithm according to the wind power output, the photovoltaic output, and the electrical load data in the extreme scenario set comprises:
constructing probability density functions of wind power output, photovoltaic output, and electrical load under extreme scenarios using a kernel density estimation method according to the wind power output, the photovoltaic output, and the electrical load data in the extreme scenario set;
performing random sampling using a Monte Carlo sampling method according to the probability density functions of wind power output, photovoltaic output, and electrical load under extreme scenarios, to generate a random scenario set; and
generating the uncertainty set of extreme scenarios using the fast convex hull algorithm according to the random scenario set.

13. The computer device according to claim 10, wherein the generating, based on the general energy storage model in the SoC form, the aggregated model for the hybrid energy storage power station using the MOGNDO algorithm comprises:
constructing a multi-objective aggregated model for the hybrid energy storage power station based on the general energy storage model in the SoC form;
solving the multi-objective aggregated model for the hybrid energy storage power station using the MOGNDO algorithm to obtain a Pareto optimal solution set; and
converting the multi-objective aggregated model for the hybrid energy storage power station using a compromise solution strategy considering fairness according to the Pareto optimal solution set, to generate the aggregated model for the hybrid energy storage power station.

14. The computer device according to claim 10, wherein the constructing the intra-region robust optimization model for wind-photovoltaic-thermal-energy storage based on the aggregated model for the hybrid energy storage power station and the uncertainty set of extreme scenarios, and solving the intra-region robust optimization model for wind-photovoltaic-thermal-energy storage using the BKA to obtain the charging and discharging power of the hybrid energy storage power station comprises:
constructing the intra-region robust optimization model for wind-photovoltaic-thermal-energy storage based on the aggregated model for the hybrid energy storage power station and the uncertainty set of extreme scenarios;
converting the intra-region robust optimization model for wind-photovoltaic-thermal-energy storage into a max-min problem model;
converting the max-min problem model into a single-layer max problem model using strong duality theory; and
solving the single-layer max problem model using the BKA to obtain the charging and discharging power of the hybrid energy storage power station.

15. The computer device according to claim 10, wherein the generating the internal coordinated dispatch plan for the hybrid energy storage power station using the niche-based gradient-directed evolution algorithm and the dispatch plan prediction model according to the charging and discharging power of the hybrid energy storage power station comprises:
generating a plurality of target charging powers and target discharging powers using a random function, with a maximum capacity of the hybrid energy storage power station as an upper limit, and generating corresponding dispatch scenarios according to the target charging powers and the target discharging powers;
constructing an internal coordinated dispatch model for the hybrid energy storage power station with an objective of satisfying the charging power and the discharging power of the hybrid energy storage power station;
solving the internal coordinated dispatch model for the hybrid energy storage power station using the niche-based gradient-directed evolution algorithm to obtain target dispatch plans under different dispatch scenarios;
generating a neural network training dataset based on the target charging powers and target discharging powers of the hybrid energy storage power station, and the target dispatch plans under the corresponding dispatch scenarios as basic data;
constructing the dispatch plan prediction model based on the CNN, the ISSA, and the BiGRU;
training the dispatch plan prediction model using the neural network training dataset to obtain a trained dispatch plan prediction model; and
inputting the charging and discharging power of the hybrid energy storage power station into the trained dispatch plan prediction model to obtain the internal coordinated dispatch plan for the hybrid energy storage power station.

16. The computer device according to claim 15, wherein the hybrid energy storage power station comprises an electrochemical energy storage system and a compressed air energy storage system; the target dispatch plan is a coordinated dispatch plan for the electrochemical energy storage system and the compressed air energy storage system within the hybrid energy storage power station.

17. The computer device according to claim 16, wherein the electrochemical energy storage system comprises a solenoid valve, a circulation pump, and a battery reactor; the compressed air energy storage system comprises a compression unit, an expansion unit, an air storage tank, and a thermal storage tank; and the constructing the internal coordinated dispatch model for the hybrid energy storage power station with the objective of satisfying the charging power and the discharging power of the hybrid energy storage power station comprises:
constructing an electric energy loss model for the electrochemical energy storage system based on losses of the solenoid valve and the circulation pump and losses of the battery reactor;
introducing a self-discharge rate coefficient based on a self-discharge problem that stored electric energy decreases after battery charging, and constructing an equivalent model for the electrochemical energy storage system;
constructing an operational model for the compressed air energy storage system based on operating conditions of the compression unit, the expansion unit, the air storage tank, and the thermal storage tank; and
constructing the internal coordinated dispatch model for the hybrid energy storage power station, with the objective of satisfying the charging power and the discharging power of the hybrid energy storage power station, and with the electric energy loss model for the electrochemical energy storage system, the equivalent model for the electrochemical energy storage system, the operational model for the compressed air energy storage system, and a relationship between the charging power and the discharging power as constraints.

18. The computer device according to claim 17, wherein the relationship between the charging power and the discharging power is that a product of the charging power and the discharging power is equal to 0.
